(19) United States
(12) Patent Application Publication
(10) Pub. No.: US 2007/0125248 A1
(43) Pub. Date: Jun. 7, 2007

(54) Embossing drum system with removable outer sleeve and methods of use

(76) Inventors: Dennis Joseph Coyle, Clifton Park, NY (US); Scott Miller, Clifton Park, NY (US)

Correspondence Address: CANTOR COLBURN, LLP, 55 GRIFFIN ROAD SOUTH, BLOOMFIELD, CT, 06002, US

(21) Appl. No.: 11/292,509

(22) Filed: Dec. 2, 2005

(51) Int. Cl. B41F 5/00

(52) U.S. Cl. 101/216

(57) ABSTRACT

In one embodiment, an embossing drum system comprise: a mandrel having outer surface with an external taper, a primary journal extending from a first end of the mandrel, a secondary journal extending from a second end of the journal, a sleeve having an inner sleeve surface with an internal taper, wherein the sleeve is disposed around the mandrel to form a drum having a substantially constant outer diameter, and a releasable journal support engaging the secondary journal, wherein a sleeve first end of the sleeve having a smallest inner diameter of the sleeve is disposed adjacent the releasable journal support. In one embodiment, a method of drum system maintenance comprises: releasing a journal support on the embossing drum system and sliding the sleeve off of the mandrel and over the secondary journal.

### BACKGROUND

Embossed films comprising specialized geometric patterns are capable of directing, diffusing, and polarizing light. These films are desirable in many applications, such as backlight displays (e.g., flat screen monitors); wherein the light emitted from the display can be directing light along the viewing axis (i.e., an axis normal (perpendicular) to the display), which enhances the perceived display brightness, while operating at reduced power consumption. The geometric patterns employed in these films can comprise prismatic features such as pyramidal or triangular elements to achieve the light directing properties. These elements can be produced utilizing several methods, such as the ultraviolet cast and cure method or the hot embossing method. In the ultraviolet cast and cure method, a photocurable liquid polymer can be distributed between an embossing drum and a thin polymer sheet. Tension on the polymer sheet and/or pressure from a rubber-covered nip roll assists to flow the polymer into the patterns on the drum surface and displacing excess polymer from the interface of the drum and the film. An ultraviolet light source can then employed to cure the polymer, which adheres to the film, creating an embossed film. The embossed film can then be stripped from the drum for further processing. The hot-embossing process comprises heating a polymer film above its glass transition temperature and forcing the film against an embossing drum. The heated polymer can flow into the surface features of the embossing drum and then cooled so that the shape of the features is retained in the film, which can then be stripped from the drum for further processing.

The quality of the resulting optical films is dependent on the quality of replication of the surface features. Therefore, if the drum's surface incurs damage (e.g., dings, scratches, warpage), or wears to the point where the optical film produced exhibits marginal optical performance, the drum must be repaired. There are two methods for providing surface features on a drum. The first is to pattern the surface of the drum itself via such processes as micromachining, photolithography, etching, laser-writing, and so forth. To repair such an embossing drum, the embossing line is shutdown to allow access to the drum, and then the drum is removed from the machine and replaced. This involves shutting down the coating line, disconnecting cooling water lines and mechanical drive components such as belts, pulleys, motors, and gearboxes, and then removing the drum completely from the machine. A new drum is then installed in the reverse manner. This can take several hours of labor to accomplish.

The second method of providing surface features on a drum is to first create a thin tool, such as an electroform, and attach it to the surface of a smooth surfaced drum via clamps, adhesives, or the like. When this tool is damaged or worn it must be replaced. This involves shutting down the coating machine, stripping off the tool, and mounting a new one on the casting drum. This can take anywhere from 1 to 3 hours, depending on operator skill. In addition the operator must get clear access to the casting drum, which typically has a nip roll, one or two UV lamps, and a stripper roll, all mounted very close to the drum making the job difficult. This procedure affects the economic performance of the film manufacturing, and is therefore desirably as short as possible. In addition, it is difficult to mount such a tool on the coating machine straight and properly registered or aligned with the machine.

What is continually needed in the art are methods and equipment to simplify repairs processes and reduce repair times. For example, what is needed in the embossing industry are devices and methods that allow for the replacement of embossing drums (and similar devices) in a reduced amount of time.

### SUMMARY

Disclosed herein are embossing drum systems, methods for their use, and methods for maintenance thereof.

In one embodiment, an embossing drum system comprise: a mandrel having outer surface with an external taper, a primary journal extending from a first end of the mandrel, a secondary journal extending from a second end of the journal, a sleeve having an inner sleeve surface with an internal taper, wherein the sleeve is disposed around the mandrel to form a drum having a substantially constant outer diameter, and a releasable journal support engaging the secondary journal, wherein a sleeve first end of the sleeve having a smallest inner diameter of the sleeve is disposed adjacent the releasable journal support.

In one embodiment, a method of drum system maintenance comprises: releasing a journal support on the embossing drum system and sliding the sleeve off of the mandrel and over the secondary journal.

The above described and other features are exemplified by the following figures and detailed description.

### BRIEF DESCRIPTION OF THE DRAWINGS

Refer now to the figures, which are meant to be exemplary and not limiting, and wherein like elements are numbered alike, and not all numbers are repeated in every figure for clarity of the illustration.

FIG. 1 is a cross-sectional view of an exemplary embossing drum.

FIG. 2a is an isometric view of an exemplary releasable journal support.

FIG. 2b is an isometric view of an exemplary modified releasable support.

FIG. 2c is an isometric illustration of an exemplary simple support.

FIG. 3 is a side view of an exemplary modified drum system.

### DETAILED DESCRIPTION

It is noted that the terms “first,” “second,” and the like, as well as “primary,” “secondary,” and the like, herein do not denote any amount, order, or importance, but rather are used to distinguish one element from another, and the terms “a” and “an” herein do not denote a limitation of quantity, but rather denote the presence of at least one of the referenced item. As used herein the term “about”, when used in conjunction with a number in a numerical range, is defined being as within one standard deviation of the number “about” modifies. The suffix “(s)” as used herein is intended to include both the singular and the plural of the term that it modifies, thereby including one or more of that term (e.g., the bearings(s) includes one or more bearings). The endpoints of all ranges directed to the same component or property are inclusive and independently combinable (e.g., ranges of “up to about 5°, or, more specifically, about 0.5° to about 3°” is inclusive of the endpoints and all intermediate values of the ranges of “about 0.5° to about 5°,” etc.).

In the film manufacturing industry there is a need for devices and methods that allow for the replacement of embossing drums (and similar devices) in a reduced amount of time. This is desired for the reason that repair of an embossing drum is time consuming and reduces the efficiency of the manufacturing line. Disclosed herein are embossing drum systems and methods for their use. These systems comprise releasable journal supports and a drum comprising a removable outer sleeve, e.g., a rigid and/or tapered outer sleeve. The system allows for the repair of the drum without requiring the drum to be removed from the machine and decreases the time required to repair a damaged or worn drum, thereby increasing operation efficiency and reducing the difficulties associated with such repairs. More specifically, the system comprises a modified embossing drum and a modified mounting system. The modified embossing drum comprises a cantilevered mandrel and a sleeve. The sleeve comprises a taper on its inside diameter that is configured to mate with a corresponding taper on the outside of the mandrel. This taper allows the embossed sleeve to be removed from one end of the mandrel. To gain access to the end of the mandrel, the modified mounting system comprises a support frame that can be opened, e.g., a clam-shell like support frame, and/or that can be loosened and removed from the mandrel.

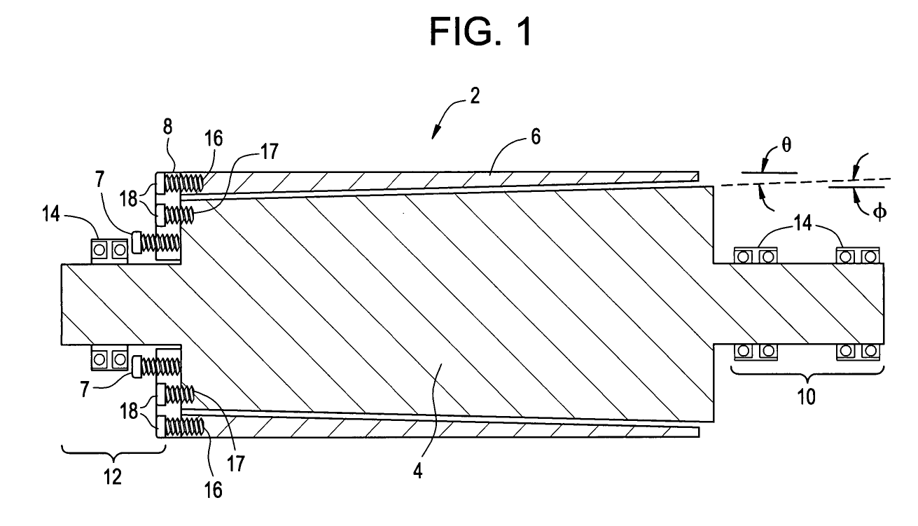

Referring now to FIG. 1, a cross-sectional view of an exemplary embossing drum, generally designated 2, is illustrated. The embossing drum 2 comprises a mandrel 4, from which a primary journal 10 and a secondary journal 12 (hereinafter referred to as “journals”) extend. The journals are capable of supporting the mandrel 4 as the drum 2 can be rotated on bearings 14 disposed on the journals during use. An embossing sleeve 6 is disposed on the mandrel 4. The embossing sleeve 6 comprises an internal taper angle (Φ) that can correspond to the external taper angle (θ) on the mandrel 4, thereby allowing the embossing sleeve to be assembled onto the mandrel 4 over the secondary journal 12 and bearing 14. The sleeve 6 can be fastened (e.g., spring-like fastened) to the mandrel 4 utilizing a retaining ring 8, which can be secured (e.g., bolted, spring-like fastener, and/or otherwise removably attached) to both components.

The mandrel 4 can be formed utilizing various machining processes (e.g., turning, milling, grinding) from materials such as metals (e.g., copper, aluminum, iron, chrome, nickel, cobalt, iron), metal alloys (e.g., martensitic, ferritic, and austenitic stainless materials), and so forth, as well as combinations comprising at least one of the foregoing. In order to manufacture the desired films, the temperature of the drum 2, and hence the mandrel 4 is controlled. As a result, thermal controls (not shown) can be disposed in the mandrel 4. For example, heat transfer fluid channels (e.g., water channels) comprising a heat transfer fluid such as water, a double-shell spiral baffle, heat exchange cartridges, and so forth, can be disposed within the mandrel 4.

The taper angle θ on the outer diameter of the mandrel 4 can be chosen based on several variables, such as the coefficients of thermal expansion of the sleeve 6 and the mandrel 4, and an ability to maximize heat transfer between the mandrel 4 and the sleeve 6. For example, the taper angle θ can be about 0.5 degrees (°) to about 10°, or, more specifically, about 0.5° to about 5°, or, even more specifically, about 0.5° to about 3°; e.g., about 1°.

The mandrel 4 and journals can be formed from one material blank (as shown), or formed separately and joined together. In one such embodiment the journals can comprise a stainless steel shaft onto which an aluminum mandrel 4 can be press-fit. Regardless of assembly and/or production method however, it is desirable that the components of the embossing drum 2 (e.g., mandrel 4, sleeve 6, retaining ring 8, bearings 14) are concentric and balanced to ensure smooth rotation without vibration or misalignment during operation.

The primary journal 14 can comprise a length that can be greater than the length of the secondary journal 12 to allow additional bearing(s) 14 to be assembled thereon. The additional bearings can be added to enable the primary section to support the drum 2 when a releasable journal support on the secondary side is removed to enable the removal of sleeve 6. The length of the journals however can comprise any length that is desired and provides the structural integrity for the particular mandrel 4. For some applications, the length of the journals can be about 2 inches (5 centimeters (cm)) to about 16 inches (41 cm), or, more specifically, about 4 inches (10 cm) to about 12 inches (30 cm). For example, the primary journal 10 can comprise a length of twelve inches (30 cm) and have two bearings 14, and the secondary journal 12 can comprise a length of four inches (10 cm) and have one bearing 14.

The diameter of the journals is dependent on several variables, such as the dimensions and weight of the mandrel 4 and sleeve 6, the strength of the material employed for the journals, and so forth. Therefore, the exact dimensions of the journal will vary with application. For example, in one embodiment, the journals can comprise a diameter of 2.5 inches (6.4 cm) for a 8 inch (20.3 cm) diameter, 24 inch (61 cm) long, mandrel 4, wherein the mandrel 4 and journals comprise 400-series stainless steel, the surface of the drum is chrome-plated, and the sleeve 6 comprises aluminum (e.g., hard-anodized aluminum, and so forth).

The sleeve 6 can have a tool comprising desired surface features, e.g., microstructures (e.g., an electroform) thereon, or can otherwise impart a desired surface to the film produced (e.g., a smooth surface, rough surface, and/or imprinted surface). This sleeve 6 can be formed utilizing various processes depending upon the type of sleeve desired for the application. Some possible processes include turning, milling, grinding, casting, injection molding, and so forth. If the sleeve 6 is used to impart an imprinted surface to the product, the sleeve 6, which can be multilayered, can comprise a pattern directly in the outer surface of the sleeve. The pattern can be disposed on the sleeve via various techniques, such as machining (e.g., micromachining), lithography (e.g., photolithography), etching, deposition, laser-writitng, and so forth. The sleeve 6 can have a sufficient thickness to be mounted to the mandrel 4, e.g., receive a fastener (such as a screw), and to be reusable. For example, the sleeve 6 can have a thickness of greater than or equal to about 1.5 millimeters (mm), or, more specifically, greater than or equal to about 3 mm, or, even more specifically, greater than or equal to about 5 mm.

The materials of the sleeve 6 depend upon the particular use and the forming technique. Possible materials include metal(s) (e.g., copper, aluminum, iron, nickel, chrome, cobalt), as well as alloys comprising at least one of the foregoing; polymeric material(s) (thermoplastics and/or thermoset). For example, the material can be rubber, or can comprise martensitic, ferritic, and/or austenitic stainless. The sleeve could also be multilayered, such as steel, aluminum, as well as other materials that impart sufficient structural integrity for the desired process, with a surface-coating (outer layer) of a material capable of comprising the desired pattern (e.g., microstructures with nanoscale resolution such as light-reflecting elements (cube-corners (e.g., triangular pyramid), trihedral, hemispheres, prisms, ellipses, tetragonal, grooves, channels, and others, as well as combinations comprising at least one of the foregoing)). For example, the surface coating can comprise a metal such as nickel (Ni), cobalt (Co), copper (Cu), silver (Ag), iron (Fe), aluminum (Al), titanium (Ti), iridium (Ir), gold (Au), chromium (Cr), beryllium (Be), tungsten (W), tantalum (Ta), molybdenum (Mo), platinum (Pt), palladium (Pd), gold (Au), among others, as well as alloys comprising at least one of the foregoing metals, and mixtures comprising at least one of the foregoing metals; e.g., copper with a surface coating of chromium and/or nickel, and so forth. Some possible alloys include a nickel-phosphorus (NiP) alloy, a palladium-phosphorus (PdP) alloy, a cobalt-phosphorus (CoP) alloy, a nickel-cobalt (NiCo) alloy, a gold-cobalt alloy (AuCo), and a cobalt-tungsten-phosphorus (CoWP) alloy.

The size and geometry of the sleeve are dependent upon the particular application and the size of the mandrel 4. The sleeve 6 can have a generally cylindrical shape that can optionally comprise a slit extending from one end to another end of the sleeve 6 (e.g., a longitudinal slit) to enable the diameter of the sleeve 6 to change as the sleeve 6 is disposed on the mandrel 4. The taper angle Φ of the sleeve 6 can be configured to match the taper angle θ to ensure proper fit and effective heat transfer therebetween. Optionally, the taper angle Φ can be different than the taper angle θ, e.g., less than the taper angle θ to cause the mandrel 4 and sleeve 6 to tightly fit together. A difference in the angles θ and Φ, however, can increase the complexity and time to remove the sleeve 6 from the mandrel 4.

The sleeve 6 is attached so as to co-rotate with the mandrel 4. Therefore, the thickness of the sleeve 6 can be configured to accept a tap 16 for a bolt, so that the sleeve 6 can be bolted to a retaining ring 8, and/or otherwise attached to attain co-rotation. The retaining ring in turn is attached to the mandrel 4 via a removable bolt 17. Other methods of removably retaining the sleeve 6 on mandrel 4 can also be employed.

Depending upon the function of the drum 2, the sleeve 6 can have a layer, such as an electroform and/or other external layer (e.g., rubber surface layer, and so forth) disposed thereon. For example, if the drum 2 will be employed in the production of light enhancement film, and the like, a tool (e.g., an electroform, and so forth) comprising a negative of the desired film surface geometry (e.g., prismatic structures and the like), can be disposed on the sleeve 6. The tool can be disposed on the sleeve 6 before or after the sleeve 6 has been disposed on the mandrel 4. For efficiency, the layer can be disposed on the sleeve 6 prior to the sleeve 6 being disposed on the mandrel 4 so that, when the sleeve on the mandrel needs replacement, the mandrel and layer, can be rapidly replaced. This tool can have a thickness of less than or equal to about 0.01 mm, or, more specifically, less than or equal to about 500micrometers (μm).

The bearings 14 employed on the journals can be designed for an extended service life and can be toleranced to provide low vibration during operation (e.g., sealed, hardened rolling element bearings). The bearings 14 can be assembled onto the journals utilizing any method, such as press-fitting. To enable rapid, facile drum repair, the drum 2 comprises a removable journal support(s) disposed at an end of the mandrel 4. When the removable journal support is unsecured and removed from a journal, the drum 2 is cantilevered from the opposite journal. Therefore, the bearing 14 should be employed that are capable of withstanding the stress when in this configuration.

The retaining ring 8 can be employed to secure the sleeve 6 to the mandrel 4. In the embodiment illustrated, bolts can be employed that can be inserted into holes 18 (e.g., counter-sunk through-holes) disposed on one face of the retaining ring 8. Furthermore, the holes 18 can comprise threads with optional jack(s) 7 (e.g., jack-bolt(s), jack-screw(s), and so forth) disposed therein. During removal of the sleeve 6 from the mandrel 4, the jack(s) 7 can be leveraged against the mandrel 4 to push the retaining ring 8 away from the mandrel 4, thereby simplifying removal of the retaining ring 8. Additionally, the retaining ring comprises hole(s) 18 that align with threaded hole(s) 17 in the mandrel 4. These threaded holes enable fastener(s) to fix the retaining ring 8 to the mandrel 4. The retaining ring 8 can comprise any material such as those described above in relation to the journals. Also, any number and configuration of holes 17 and 18 can be employed. The inside diameter of the retaining ring 8 is desirably a diameter that can fit over the bearing(s) 14 on the secondary journal 12 to enable facile removal of the ring and sleeve during drum repair.

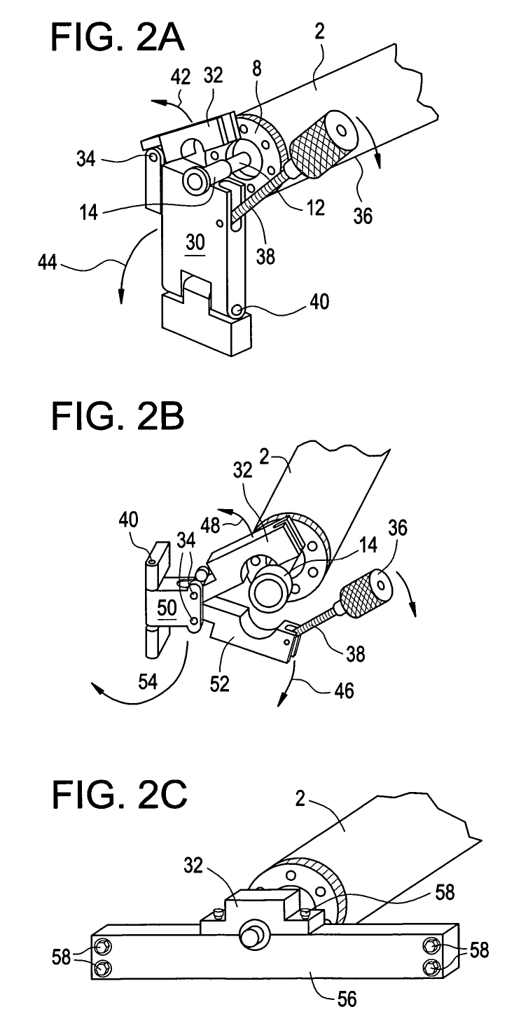

Referring now to FIG. 2a that shows an isometric view of an exemplary releasable journal support. The drum 2 is supported by a releasable journal support 30 that contacts the bearing 14 located on the secondary journal 12. The releasable journal support 30 comprises an upper jaw 32 that is capable of opening at a pivot 34 as shown by the directional arrow 42. A collar 36 is disposed on a threaded rod 38 that can be employed to secure the upper jaw 32 onto the bearing 14. When the upper jaw 32 is released (unsecured), the releasable journal support 30 can be rotated away from the drum 2 via hinge 40 e.g., in the direction illustrated by the directional arrow 44. Once away, the bolts (not shown) employed to secure the retaining ring 8 to the mandrel 4 can be removed and the sleeve 6 can be removed from the mandrel 4 (jack-bolts can optionally be used to pull the sleeve 6 from the mandrel).

The releasable journal support 30 can comprise any design that is capable of being removed from the drum on the side from which the sleeve 6 is to be removed; i.e., the side where the inner diameter of the sleeve is the smallest.

FIG. 2b illustrates an isometric view of another embodiment of a releasable support; a modified releasable support. The modified releasable support 50 comprises an upper jaw 32 and a lower jaw 52, which are free to open away from the bearing 14 (indicated by the directional arrows 46, 48) at pivots 34. The upper jaw 32 and lower jaw 52 are also capable of securing bearing 14 via a collar 36 that is attached to a threaded rod 38. In addition, when the upper jaw 32 and lower jaw 52 are unsecured, the modified releasable support 50 can swing away form the bearing 14 via a hinge 40, as indicated by the directional arrow 54.

Yet another embodiment of the releasable support is illustrated in FIG. 2c. In this embodiment, the upper jaw 32 can be bolted to a simple support 56 via bolts 58. The simple support 56 can be bolted to the frame (not shown) of the production equipment via bolts 58. To gain access to the drum 2, the bolts 58 securing the upper jaw 32 can be removed, and the simple support 56 can also be removed by removing the bolts therein.

The releasable journal support 30, modified releasable support 50, and simple support 56 (hereinafter referred to as “releasable journal supports”) can comprise materials such as those described above in relation to the journals. Desirably, the releasable journal supports are fabricated to resist wear, which can cause misalignment of the journals and/or premature bearing failure over a prolonged service life.

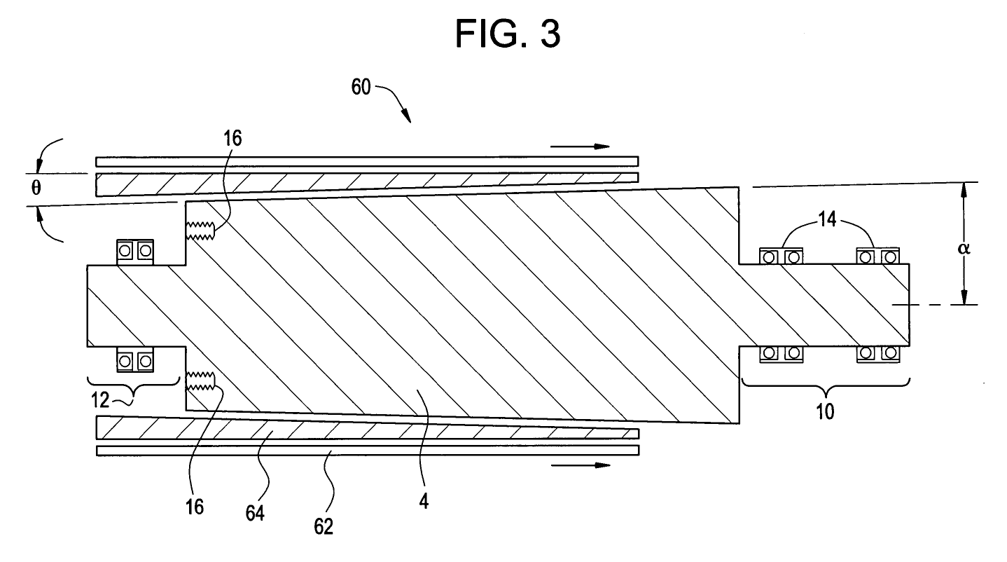

Referring now to FIG. 3, a side view illustrating an exemplary modified drum system generally designated 60. A sleeve 64 is disposed partially assembled onto a mandrel 4. The sleeve 64 comprises an internal taper angle that is equivalent to the mandrel taper angle θ. The outside diameter of the sleeve 64 is concentric with the mandrel 4 and a constant diameter (non-tapered). The sleeve 64 also comprises a slit (not shown), which is disposed along the entire length of the sleeve 64 so that as the sleeve 64 is advanced onto the mandrel 4, the sleeve 64 can expand in diameter. Disposed around the sleeve 64 can be an electroform 62. The electroform 62 comprises a tubular shape that can comprise an embossing pattern on its outer surface and a smooth bore on it's inner surface. The electroform 62 can be secured to the modified drum 60 by advancing the sleeve 64 onto the mandrel 4 as indicated by the directional arrows. The sleeve 64 expands in outer diameter as it is advanced onto the mandrel 4. The expanding sleeve 64 can engage the electroform 62 to secure the electroform 62 onto the mandrel 4. The retaining ring 8 can then be bolted to the mandrel 4 and/or to the sleeve 64.

The sleeve 64 and electroform 62 can the toleranced to minimize the width of the slit once the sleeve 64 have been disposed on the mandrel 4. Since the portion of electroform 62 spanning the slit is unsupported, and if the slit is wide, the electroform 62 can deflect under the pressure of the film manufacturing process and yield a recurring blemish on the film product. The width of the slit once the sleeve 64 has been assembled onto the mandrel 4 can be less than or equal to about 0.5 inches (1.3 cm), or, more specifically, less than or equal to about 0.25 inches (0.6 cm), and even more specifically, less than about 0.1 inches (0.2 cm).

The electroform 62 can be formed utilizing typical electroforming processes, or could be a plastic tool formed by a molding, pressing, machining, grinding, and/or other process. The electroform can comprise metals such as nickel (Ni), cobalt (Co), copper (Cu), iron (Fe), aluminum (Al), titanium (Ti), iridium (Ir), gold (Au), chromium (Cr), beryllium (Be), tungsten (W), tantalum (Ta), molybdenum (Mo), platinum (Pt), palladium (Pd), among others, as well as alloys comprising at least one of the foregoing metals, and mixtures comprising at least one of the foregoing metals. Some possible alloys include a nickel-phosphorus (NiP) alloy, a palladium-phosphorus (PdP) alloy, a cobalt-phosphorus (CoP) alloy, a nickel-cobalt (NiCo) alloy, and a cobalt-tungsten-phosphorus (CoWP) alloy. For example, in one embodiment, the sleeve 64 can comprise aluminum that is anodized for increased wear resistance, and the electroform 62 can comprise a nickel-cobalt alloy and can have a thickness of 50 micrometers (μm) to about 500 μm.

Previously, drum repair and/or electroform replacement was time consuming and difficult. For example, a casting drum would have a smooth surface with the electroform attached by double-sided tape. Repair and replacement would require the operator to strip off the electroform, strip off the tape, clean adhesive residue off of the roll, then to apply new tape and finally the new electroform. Great care would need to be taken to apply both tape and electroform smoothly; i.e., with no wrinkles or air pockets that could cause defects. If there are any defects, the tool and tape would be stripped off and the process would be repeated.

Another way an electroform was mounted was to use a clamping mechanism on the surface of the drum to grip the ends of the electroform. In this case, the operator would still have to mount the tool by hand. The disadvantage of this process was that the clamping mechanisms were bulky and inhibited good heat transfer between the drum and the electroform. Additionally, removal of the electroform could be difficult due to the difficulty of accessing the bulky clamping mechanism.

Disclosed herein, embossing drum systems comprise removable sleeves/films and releasable journal supports that can reduce costly downtime of production equipment and allow for easier drum system repair. Furthermore, these drum systems can be retrofitted on existing production equipment to provide these benefits on older equipment as well. It is to be noted the drum systems described herein can be used in various applications, including as a hot press roller, a film guide roller, an imprinting roller, a chill roller, and so forth.

It is also noted that a coating process (e.g., ultraviolet (UV) cast and cure process) can be used for making films (e.g., prismatic brightness enhancement films). The UV-curable liquid resin is sandwiched between plastic film supplied from a roll and a tool (e.g., an electroform) attached to the surface of a temperature-controlled casting drum. The resin fills this “tool” or “mold” so that when it is cured via UV light and stripped from the tool, the coating on the plastic film is a replica of the tool. This tool is a discrete rectangular piece so that coating must be applied in patches aligned with the tool. Issues with this process can include: overcoating the ends of the tool can cause it to be ripped from the drum or damaged; patch coating requires a more complex coating machine; creating the tooling uses an electroforming operation, additional complexity; there is much waste of materials and machine capacity; the area between patches and the starting and trailing ends of the patches are scrap; and most times the product size (rectangular pieces that fit one particular LCD display) does not make efficient use of the patch size generating much more scrap.

As noted above, the surface features can be disposed in the sleeve, e.g., a multilayer sleeve. It is also understood that the surface features can be disposed directly into the mandrel. The surface features can be disposed directly into the sleeve or mandrel with various processes such as such as machining (e.g., micromachining, diamond-machining, and so forth), lithography (e.g., photolithography), etching, deposition, laser-writing, and so forth. Optionally, a thin layer (e.g., less than or equal to about 10 μm thick, or, even more specifically, about 1 nanometer (nm) about 1 μm thick), can be disposed over the surface features, e.g., to enhance the hardness and/or chemical stability of the surface features.

Materials for the sleeve, mandrel, and any thin layer include the materials described above for the sleeve, electroform, and surface layer. For example, the material(s) can be materials that enable: a thin, uniform, surface coating having sufficient density so as to not change the optical properties of the microstructure (e.g., tips remain sharp), with an average surface roughness (Ra) of less than or equal to about 10 nm; the surface is scratch-resistant and chemical resistant (e.g., chemically inert in relation to the coating materials), for example, as compared to copper; and/or where no surface layer (e.g., thin layer) is employed, the base material(s) can themselves be scratch-resistant and chemical resistant, and can be diamond-turnable to give equivalent tip sharpness and surface roughness.

Use of the surface features directly in the sleeve and/or mandrel allows for efficient mass production of microstructured plastic films, eliminates the need for an electroforming (or other tool) factory, simplifies the equipment, and eliminates the need to address tool seams and patch coating. This technique and equipment can greatly improve materials useage efficiency and coating machine capacity, e.g., each improvement by a factor of about 2 to 3 times.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from essential scope thereof. Therefore, it is intended that the invention not be limited to the particular embodiment disclosed as the best mode contemplated for carrying out this invention, but that the invention will include all embodiments falling within the scope of the appended claims.

What is claimed:

1. An embossing drum system, comprising:
a mandrel having outer surface with an external taper;
a primary journal extending from a first end of the mandrel;
a secondary journal extending from a second end of the journal;
a sleeve having an inner sleeve surface with an internal taper, wherein the sleeve is disposed around the mandrel to form a drum having a substantially constant outer diameter; and
a releasable journal support engaging the secondary journal, wherein a sleeve first end of the sleeve having a smallest inner diameter of the sleeve is disposed adjacent the releasable journal support.

2. The embossing drum system of claim 1, further comprising bearings disposed on the primary journal.

3. The embossing drum system of claim 1, further comprising a retaining ring mechanically engaging the sleeve first end.

4. The embossing drum system of claim 1, wherein the releasable journal support comprises an upper jaw pivotably attached to a body portion, wherein the secondary journal extends through the releasable journal support between the upper jaw and the body portion.

5. The embossing drum system of claim 4, wherein the body portion is pivotable away from the mandrel.

6. The embossing drum system of claim 1, wherein the releasable journal support further comprises a release comprising a rod and a collar, wherein the rod physically engages the upper jaw.

7. The embossing drum system of claim 1, further comprising a tool disposed around at least a portion of the sleeve, wherein the tool comprises microstructures.

8. The embossing drum system of claim 7, wherein the sleeve comprises a longitudinal slit, and wherein the tool has a tubular geometry.

9. The embossing drum system of claim 8, wherein the tool has a tubular geometry that is disposed on the outer sleeve surface.

10. The embossing drum system of claim 7, wherein the tool is a plate attached to the sleeve.

11. The embossing drum system of claim 7, wherein the sleeve has a sleeve thickness of greater than or equal to about 1.5 mm, and wherein the tool has a tool thickness of less than or equal to about 0.01 mm.

12. The embossing drum system of claim 1, wherein the inner sleeve surface and an outer surface of the mandrel comprise different materials.

13. The embossing drum system of claim 1, wherein the sleeve is attached to the mandrel with a spring-like fastener.

14. The embossing drum system of claim 1, wherein the external taper and the internal taper have a common taper angle.

15. The embossing drum system of claim 1, wherein the internal taper has a taper angle of about 0.5° to about 10°.

16. The embossing drum system of claim 15, wherein the taper angle is about 0.5° to about 3°.

17. A method of drum system maintenance, comprising:
releasing a journal support on a drum system, wherein the drum system comprises:
a mandrel having outer surface with an external taper;
a primary journal extending from a first end of the mandrel;
a secondary journal extending from a second end of the journal;
a sleeve having an inner surface with an internal taper, wherein the sleeve is disposed around the mandrel to form a drum having a substantially constant outer diameter; and,
the releasable journal support engaging the secondary journal, wherein a sleeve first end of the sleeve having a smallest inner diameter of the sleeve is disposed adjacent the releasable journal support; and
sliding the sleeve off of the mandrel and over the secondary journal.

18. The method of claim 17, further comprising removing a retaining ring from a sleeve first end prior to sliding the sleeve.

19. The method of claim 18, wherein the mandrel and the sleeve comprise materials having different coefficients of thermal expansion, and further comprising heating or cooling the mandrel and sleeve prior to sliding the sleeve.

20. The method of claim 17, wherein the drum system further comprising an electroform disposed around at least a portion of the sleeve, and wherein the electroform is removed simultaneously with the sleeve.

21. The method of claim 17, further comprising sliding another sleeve onto the mandrel, engaging a ring with the sleeve and the mandrel, and securing the releasable journal round the secondary journal.

22. The method of claim 17, wherein the electroform is a continuous tube, further comprising sliding another sleeve onto the mandrel and expanding the another sleeve onto the mandrel to tighten the electroform.

23. An embossing drum system, comprising:
a mandrel having outer surface with an external taper;
a journal extending from an end of the mandrel;
a sleeve having an inner sleeve surface with an internal taper, wherein the sleeve is disposed around the mandrel to form a drum having a substantially constant outer diameter,
a tool disposed on the sleeve, wherein an outer tool surface comprises molds for light-refracting elements; and
a releasable journal support engaging the journal, wherein a sleeve first end of the sleeve having a smallest inner diameter of the sleeve is disposed adjacent the releasable journal support;
wherein the mandrel and the sleeve comprise materials having different coefficients of thermal expansion.
